(19) United States
(12) Patent Application Publication
(10) Pub. No.: US 2018/0251220 A1
(43) Pub. Date: Sep. 6, 2018

(54) METHOD FOR THE LINEAR SEPARATION AND CONNECTION OF TWO ELEMENTS

(71) Applicant: ArianeGroup SAS, Paris (FR)

(72) Inventor: Felipe MEDINA, La Celle-Saint-Cloud (FR)

(73) Assignee: ArianeGroup SAS, Paris (FR)

(21) Appl. No.: 15/757,233

(22) PCT Filed: Sep. 2, 2016
(86) PCT No.: PCT/EP2016/070743

§ 371 Date: Mar. 2, 2018

(30) Foreign Application Priority Data
Sep. 3, 2015 (FR) 1558166

(51) Int. Cl. B64D 1/02; B64G 1/64

(52) U.S. Cl. CPC B64D 1/02; F42B 15/38; B64G 1/645

(57) ABSTRACT

The invention relates to a method and a device allowing the separation of two stages of an aeronautical vehicle, without affecting the structure of the two stages. The device consists mainly of a connecting ring (13) secured to the two stages of the aeronautical vehicle and comprising a cutting ring (20) on the inner surface (13A) thereof, which contains a mixture of thermite and an intermetallic composition. The triggering of the latter allows the heating and melting of part of the ring (13), which separates into two parts. The invention can be applied to an aeronautical launcher.

### FIELD OF THE INVENTION

The invention relates to a linear separation, as smooth as possible, of a first element in relation to a second element, which are previously connected rigidly. The invention applies, preferably, to space launchers, for separating stages from each other or a stage from a useful load, to missiles, space probes, even to aircraft where dropping a useful load is involved. This separation aims to reduce the mass of the boarded assembly, or to drop a useful load. These applications are characterised by the fact that it is needed to separate objects which can be fragile, for example, a satellite, and of which the connection has had to undergo high mechanical loads, like those undergone during the propulsion by a launcher.

### PRIOR ART AND PROBLEM RAISED

FIGS. 1A and 1B illustrate this principle of separation between two elements 1 and 2 of a launcher. The first element 1 is, preferably, an element of row n, preferably, a first engine stage. The second element is an element of row n+1, either a second engine stage, or a useful load, for example, a satellite. The linear separation, in the axis of the launcher, must therefore be made without damaging the base of the second element and, in the case where the first element 1 is wanted to be recovered, without damaging its surface, where the connection between the two elements 1 and 2 was located.

In the current state of the art, the connection/separation system is mainly of four types, which are as follows:

1) connections by bolting, riveting and pyrotechnical cutting by local melting of the structure. These systems, by their functioning, create debris from ejected material. In addition, the cutting causes a significant impact in the structure, which can be damaging for useful loads of the launcher;

Patent document FR 2 947 808 shows an example of implementing such a solution.

2) connections by riveting and pyrotechnical cutting by rupturing the structure, by deforming a pyrotechnical element. This solution is the most used and does not create any debris, but causes a very significant impact;

3) connections by pyrotechnical bolting and rupturing or separating the nut. This type of solution creates a lot less impacts than the two preceding solutions, but requires several bolts to transmit the stresses from one element to the other, therefore implying increased risks of failure because of the number of devices involved;

4) connections by straps and rupturing these connections by pyrotechnical bolts. This type of solution does not allow large stresses to be transmitted between the two elements and does not enable too large diameters for the launchers. In this case also, loosening the constraints causes a significant impact in the structures.

Generally, in the current state of these techniques, the systems deriving from these connection/separation solutions have the specificity of leaving, most of the time, rough patches on the outer form of the launcher, after the separation.

The aim of the invention is to overcome the aforementioned disadvantages.

On the other hand, by the patent document U.S. Pat. No. 5,402,728, a self-destructing bolting device implementing thermite is known.

### OBJECTS OF THE INVENTION

To this end, a first main object of the invention is a method for the linear connection and separation of two elements that have to be securely separated, these two elements being connected linearly to each other by a defined local connection, the separation needing to occur by the quick and partial warming-up of the assembly, at or around the connection, this warming-up being triggered remotely.

According to the invention, the method consists of:
connecting the two elements by a connecting element;
equipping this connecting element with a mixture of thermite and an intermetallic composition, that can be started by a controlled electrical connection; and
pyrotechnically triggering said mixture to cause the warming-up and the splitting into two parts of the connecting element.

The second main object is a device for the linear connection and separation of two elements, a first element and a second element, linearly connected to each other by a defined local connection and that have to be securely separated, the separation occurring by the quick and partial warming-up of a determined part of the connection, this warming-up being triggered remotely.

According to the invention, it comprises:
a connecting element constituting the connection between these two elements, namely the first element and the second element;
a mixture of thermite and an intermetallic composition that generates heat, placed against the connecting element; and
means for remotely pyrotechnically triggering the mixture.

In a first embodiment of this device, the connecting element is constituted of a separate part, not forming any part of the two first and second elements.

In a second embodiment of this device, the connecting element constitutes the extension of an outer wall of one of these two elements, namely the first element and the second element.

Preferably, the mixture used is placed in a cutting ring, itself placed against the inner wall of the connecting element.

This cutting ring is constituted, preferably, of a closed body containing the mixture and constituting a toroidal ring.

In a first embodiment of the invention, the closed cutting ring is secured to the intermediate structure by securing means which are placed between the place where the connecting element must be cut and the first stage, the first stage being the carrier, to remain connected to this first carrier stage.

In a second embodiment of the invention, the closed toroidal ring is constituted by two concentric walls of the connecting means, connected to the second supporting stage, two insulating annular layers placed in two parallel planes between the two walls, and perpendicular to them, the connecting means finished with a part connected to the first stage and secured to the two walls by a mechanical connection, the cutting of the element being done at the level of the two concentric walls.

A third main object of the invention is an aeronautical launcher comprising at least one central propeller, being a carrier, constituting the first element, and at least one stage, being carried, secured on the central propeller and constituted by the second element.

According to the invention, this launcher comprises a device such as previously defined.

The closed cutting ring can be secured to the connecting element placed between the place where the cutting of the connecting element must occur and the first carrier stage of the launcher, in order to remain connected to this first carrier stage.

In another embodiment, the closed cutting ring can be constituted by two concentric walls of the connecting means connected to the second stage and two insulating annular layers placed between the two concentric walls, the connecting means finished with a part connected to the first stage and secured to the two concentric walls by a mechanical connecting means, the cutting of the connecting element being done at the level of the two concentric walls.

### LIST OF FIGURES

The invention is the different characteristics and embodiments thereof will be best understood upon reading the following description, accompanied by several figures defining, respectively:

FIGS. 1A and 1B, a diagram representing the separation of two elements of an aeronautical launcher;

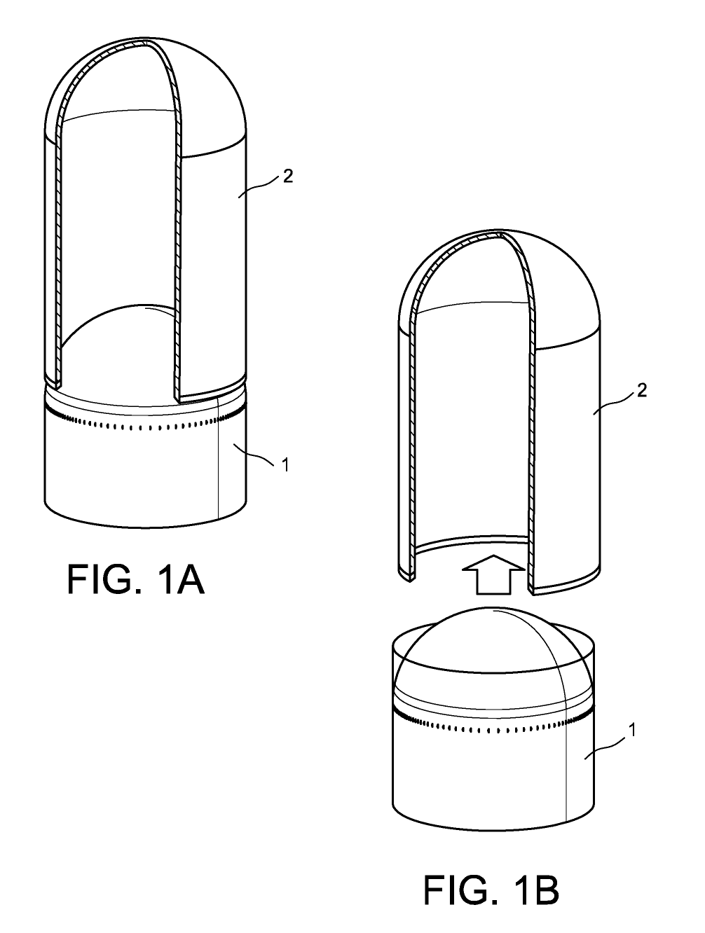

FIGS. 2A, 2B, 2C, three diagrams representing the application of the invention on an aeronautical launcher;

FIGS. 3A, 3B and 3C, diagrams relating to the functioning of the device according to the invention; and

FIG. 4, in a cross-section, a specific embodiment of the invention.

### DETAILED DESCRIPTION OF THE INVENTION

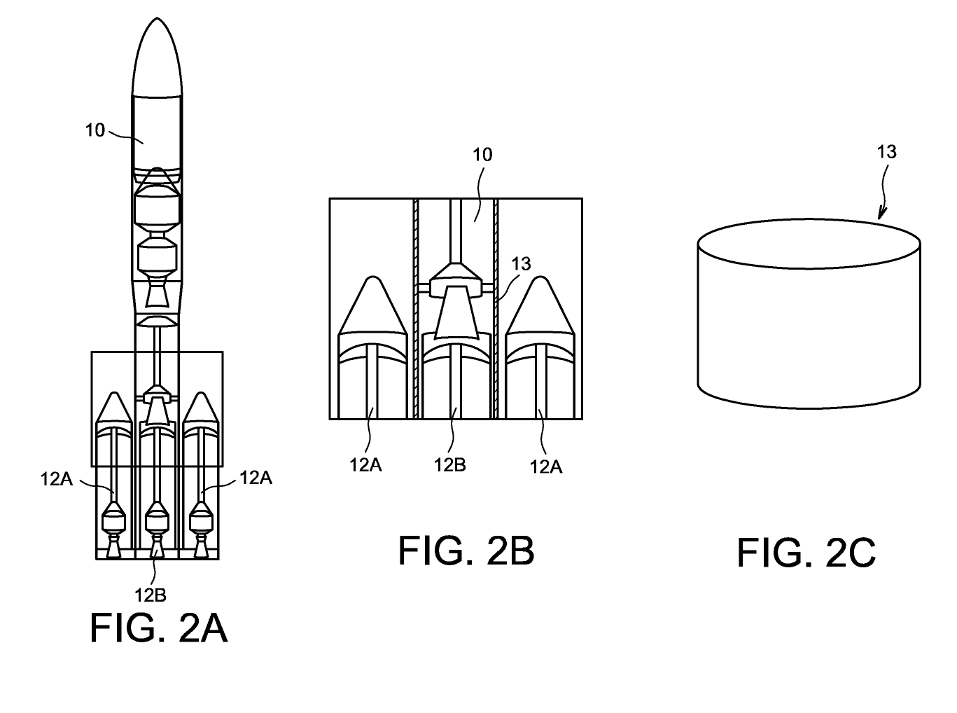

FIG. 2A represents the stages 10 of an aeronautical launcher, equipped with several propellers 12A and 12B, placed at the base of the stages 10 of the aeronautical launcher.

FIG. 2B shows a detail of this assembly, in particular, at the level of the upper part of the propellers 12A and 12B. Indeed, it can be seen that the central propeller 12B is surmounted by the stages 10. The connection is made by a connecting element 13, which is represented separate in FIG. 2C.

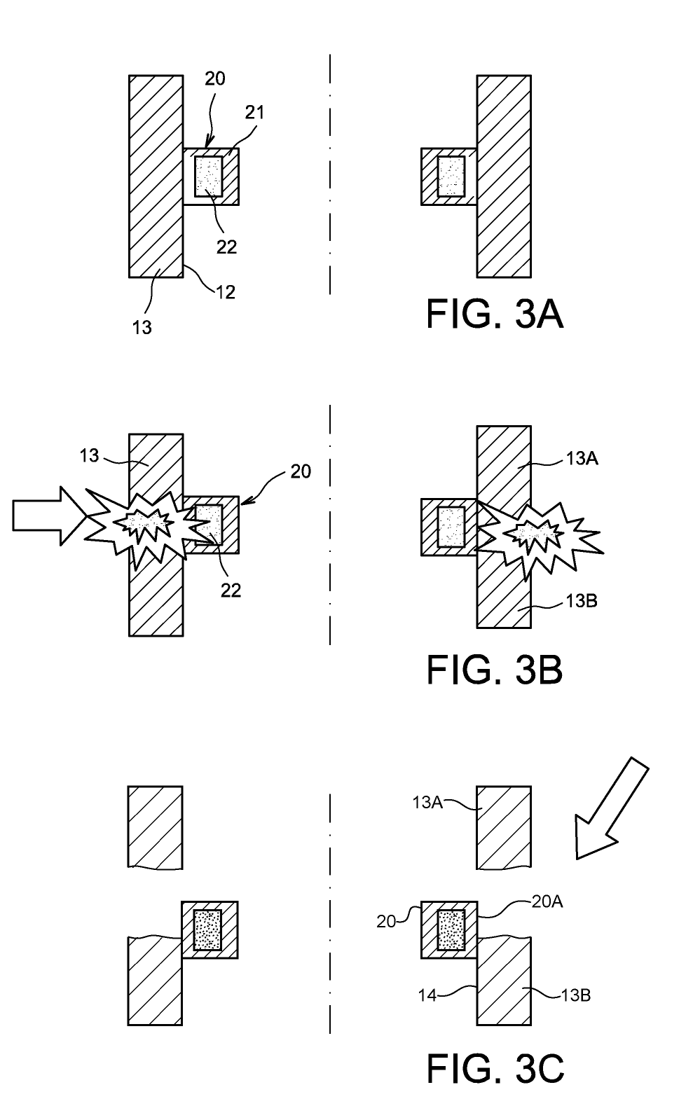

The device according to the invention, as well as the implementation method, are illustrated in FIG. 3A, in a detailed cross-section, at the level of the connecting element 13. This comprises, on the inner wall 14 thereof, a cutting ring 20. The latter is mainly constituted of a body 21, toroidal and open on the side of the outer diameter thereof. It is filled with a pyrogenic, energetic or thermite material 22. It is specified that by the term thermite, nanothermites are also covered.

In reference to FIG. 3B, the firing of the material 22, constituting a pyrotechnical substance, causes a sudden warming-up, until the melting of the parts of the connecting element 13 located facing this material 22. The heating of this part of the connecting element 13, until the melting point thereof, causes the separation of this connecting element 13, into two parts. These two parts are represented in FIG. 3C, an upper part 13A and a lower part 13B. It is understood, in this FIG. 3C, that the cutting ring 20 has previously been secured by one of its edges 20A on the wall 14 of the connecting element 13. Hence, after the separation of the two lower 13B and upper 13A parts of the connecting element 13, the cutting ring 20 remains connected to one of the two parts, in this case, the lower part 13B of the connecting element 13. Indeed, in the application to an aeronautical launcher, it is chosen that the cutting ring 20 remains connected to the lower stage, which does not continue the flight of the aeronautical craft and falls back onto the ground. This allows to avoid the structure continuing the flight to be heated for a longer duration than necessary.

In two different embodiments of the device according to the invention, the connecting element 13 can be a separate part, in other words, not forming part of a first element, nor of a second element, which must be separated, namely the stages 10 and the central propeller 12B. This connecting element 13 is thus either welded or bonded, screwed, bolted, by its two ends, to each one of these two elements.

In a second embodiment, it is provided that the connecting element 13 forms an integral part of the wall of one of the two elements, preferably the lower element, namely the central propeller 12B. In other words, in this case, the connecting element 13 is the extension of the outer wall of this central propeller 12B.

Furthermore, it can also be considered that the two parts 13A and 13B of the connecting element are two different parts, connected to each other, for example, by soldering, by bonding or otherwise.

The remote pyrotechnical triggering means are provided to initiate the reaction of the material 22.

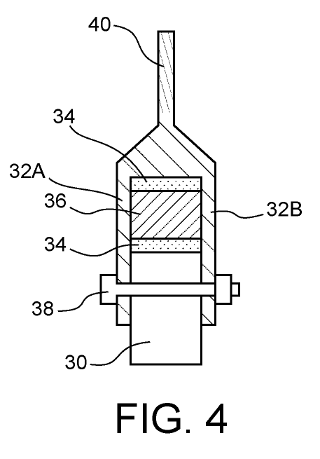

In reference to FIG. 4, a specific embodiment of the invention provides for the wall of the second stage 40 being finished with two concentric walls 32A and 32B inside which the thermite mixture and intermetallic composition are located. To confine this mixture, two insulating layers 34 are used, placed above and below the mixture.

The connection with the first stage 30 is made by mechanical means, for example, bolts 38 crossing the two concentric walls 32A and 32B and the end of the outer wall of the first stage of the launcher. The rupture is made therefore on the concentric walls 32A and 32B, at the level of the thermite solution mixture/intermetallic compositions.

What is claimed is:

1. A method for connecting and separating a first element and a second element,
the method comprising the following steps:
connecting the first element and the second element together by a connecting element (13) so as to define a local linear connection between the first element and the second element;
arranging a mixture of thermite and an intermetallic composition, that can be started by a controlled electrical connection, against the connecting element; and
pyrotechnically triggering the mixture (22) to cause the quick warming-up and the splitting into two parts of the connecting element (13).

2. A device for connecting and separating a first element and a second element,
the device comprising:
a connecting element (13) which connects the first element and the second element together;
a mixture of thermite and an intermetallic composition that generates heat, placed against the connecting element (13); and
means for remotely pyrotechnically triggering the mixture (22) to cause the quick warming-up and the splitting into two parts of the connecting element (13).

3. The device according to claim 2, wherein the connecting element (13) is a connecting ring from the first and second elements and having two ends respectively fastened to the first and second elements.

4. The device according to claim 2, wherein the connecting element (13) is an extension of an outer wall of one of the first element and the second element.

5. The device according to claim 2, wherein the mixture (22) is placed in a cutting ring (20) of closed toroidal shape, placed against an inner wall (14) of the connecting element.

6. The device according to claim 5, wherein the cutting ring (20) is constituted of a closed body (21) containing the mixture (22).

7. An aeronautical launcher comprising a carried stage (10), a carrying stage or central propeller (12B) carrying the carried stage (10), and a device according to claim 2, wherein the first element for the device is the carried stage, and wherein the second element for the device is the carrying stage or central propeller (12B).

8. The launcher according to claim 7, wherein the device is a device according to claim 5, and wherein the cutting ring (20) is secured to the connecting element (13) by securing means placed between a region where the connecting element is to be cut and the carrying stage (30), such that the connecting element remains connected to the carrying stage or central propeller (12B) after the splitting into two parts of the connecting element (13).

9. The launcher according to claim 7, wherein the connecting element (13) is defined by two concentric walls (32A, 32B) extending from an end of a wall of the carried stage, wherein mechanical connecting means connect the two concentric walls (32A, 32B) and an end of an external wall of the carrying stage (30) together, wherein two insulating annular layers (34) are arranged between the two concentric walls (32A, 32B), respectively above and below the mixture (36) of thermite and the intermetallic composition.
